(19) United States
(12) Patent Application Publication
(10) Pub. No.: US 2021/0063331 A1
(43) Pub. Date: Mar. 4, 2021

(54) DILATOMETER

(71) Applicant: Stress Engineering Services, Inc., Mason, OH (US)

(72) Inventor: Shannon R. Read, Lebanon, OH (US)

(21) Appl. No.: 17/002,875

(22) Filed: Aug. 26, 2020

Related U.S. Application Data
(60) Provisional application No. 62/891,576, filed on Aug. 26, 2019.

(51) Int. Cl. G01N 25/16; G01N 25/48

(52) U.S. Cl. CPC G01N 25/16; G01N 25/488

(57) ABSTRACT

A dilatometer includes a housing, a sample carrier and a dimensional sensor. The housing defines a test chamber and an inlet port in communication with the test chamber. The sample carrier is disposed in the test chamber and includes a sample retention portion. The sample retention portion is configured to retain a material sample thereto. The dimensional sensor is coupled with the sample carrier and is configured to facilitate detection of dimensional changes in the material sample.

### REFERENCE TO RELATED APPLICATION

This application claims priority of U.S. provisional patent application Ser. No. 62/891,576, entitled Dilatometer, filed Aug. 26, 2019, and hereby incorporates this provisional patent application by reference herein in its entirety.

### TECHNICAL FIELD

This application relates generally to a dilatometer that facilitates exposure of a material sample to fluidic (e.g., liquid or gas), pressure, and/or thermal conditions to detect occurrence of metallurgical changes and acquire engineering data such as displacement data and change rate data.

### BACKGROUND

Conventional dilatometers are configured to facilitate thermal testing of a material sample.

### BRIEF DESCRIPTION OF THE DRAWINGS

It is believed that certain embodiments will be better understood from the following description taken in conjunction with the accompanying drawings in which:

FIG. 1 is an isometric view depicting a dilatometer in association with a fluid source, in accordance with one embodiment;

FIG. 2 is a cross-sectional view taken along the line 2-2 in FIG. 1;

FIG. 3 is an exploded isometric view depicting the dilatometer of FIG. 1 with certain components removed for clarity of illustration;

FIG. 4 is a cross-sectional view taken along the line 4-4 in FIG. 3;

FIG. 5 is an end elevation view depicting a housing of the dilatometer of FIG. 1; and

FIG. 6 is a cross-sectional view taken along the line 6-6 in FIG. 3;

FIG. 7 is a cross-sectional view taken along the line 7-7 in FIG. 3;

FIG. 8 is a cross-sectional view taken along the line 8-8 in FIG. 3;

FIG. 9 is a top plan view depicting a sample carrier of the dilatometer of FIG. 1;

FIG. 10 is a side elevation view depicting the sample carrier of the dilatometer of FIG. 1;

FIG. 11 is an isometric view depicting a tube furnace;

FIG. 12 is a sectional view depicting a dilatometer in association with a fluid source, in accordance with another embodiment;

FIG. 13 is an exploded isometric view depicting the dilatometer of FIG. 12 with certain components removed for clarity of illustration;

FIG. 14 is an exploded view depicting a sample carrier of the dilatometer of FIG. 12 in association with a material sample; and

FIG. 15 is a rear perspective view depicting a tip portion and a sensor retention portion of the sample carrier of FIG. 14.

### DETAILED DESCRIPTION

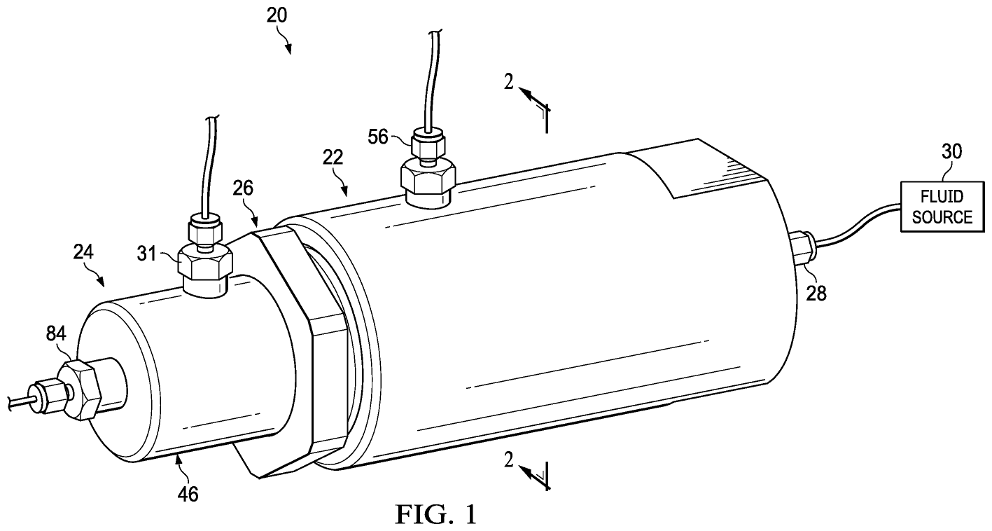

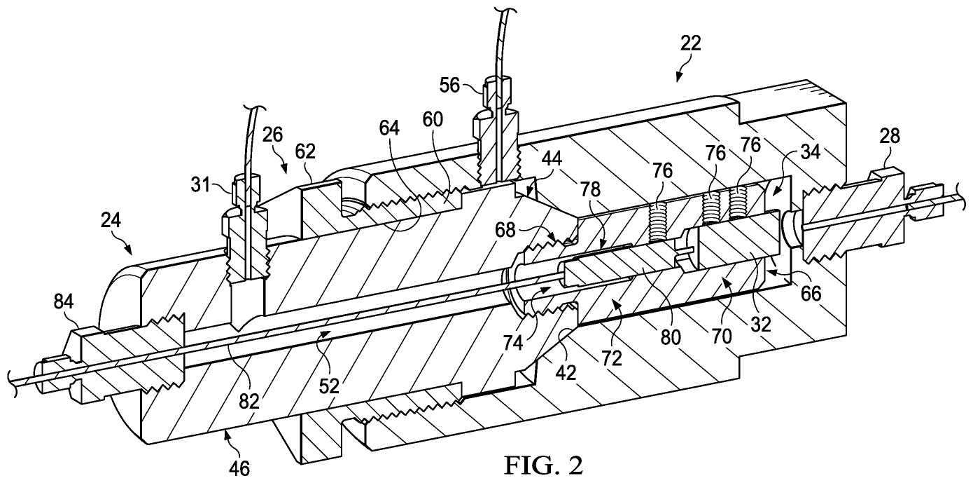

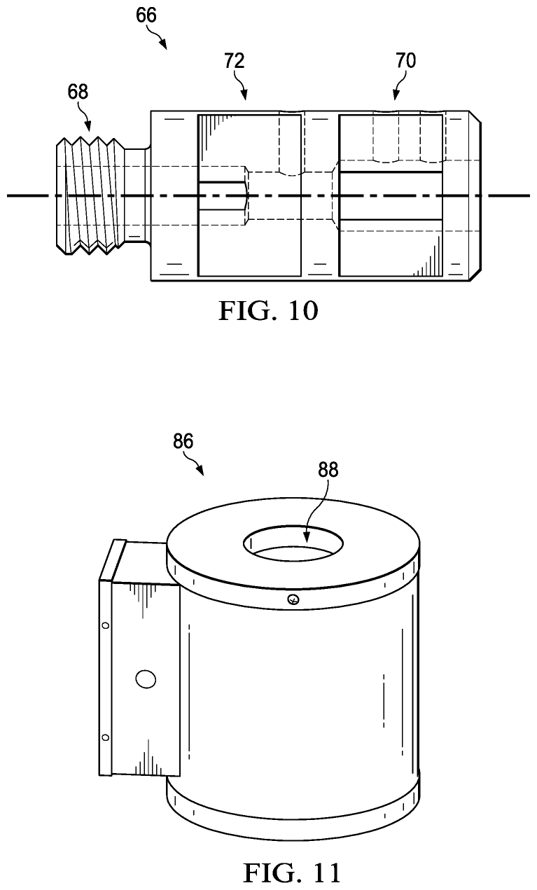

Embodiments are hereinafter described in detail in connection with the views and examples of FIGS. 1-15, wherein like numbers indicate the same or corresponding elements throughout the views. As illustrated in FIGS. 1-3, a dilatometer 20 can include a housing 22, a plug body 24 disposed at least partially in the housing 22, and a compression fitting 26 that surrounds the plug body 24 and is threaded into the housing 22. A fluid inlet fitting 28 can be coupled with the housing 22 and can be in fluid communication with a fluid source 30 (e.g., a liquid source or a gas source). A fluid outlet fitting 31 can be coupled with the plug body 24 and can be in fluid communication with the fluid source 30. Fluid from the fluid source 30 can flow through the fluid inlet fitting 28, through the housing 22, and out of the fluid outlet fitting 31 for return back to the fluid source 30. It is to be appreciated that any of a variety of suitable control arrangements (e.g., valves) (not shown) can be provided along the fluid path to facilitate control over fluid flow during testing. A material sample 32 (FIG. 2) can be disposed within the housing 22 and exposed to pressurized fluid from the fluid source 30. As will be described in further detail below, when the material sample 32 is exposed to the pressurized fluid from the fluid source 30 and is simultaneously heated, the dimensional change of the material sample 32 can be measured to determine the effect of the pressurized fluid and temperature on the material sample 32. In one embodiment, the housing 22, the plug body 24, and the compression fitting 26 can be formed of a thermally conductive material such as stainless steel or aluminum, for example.

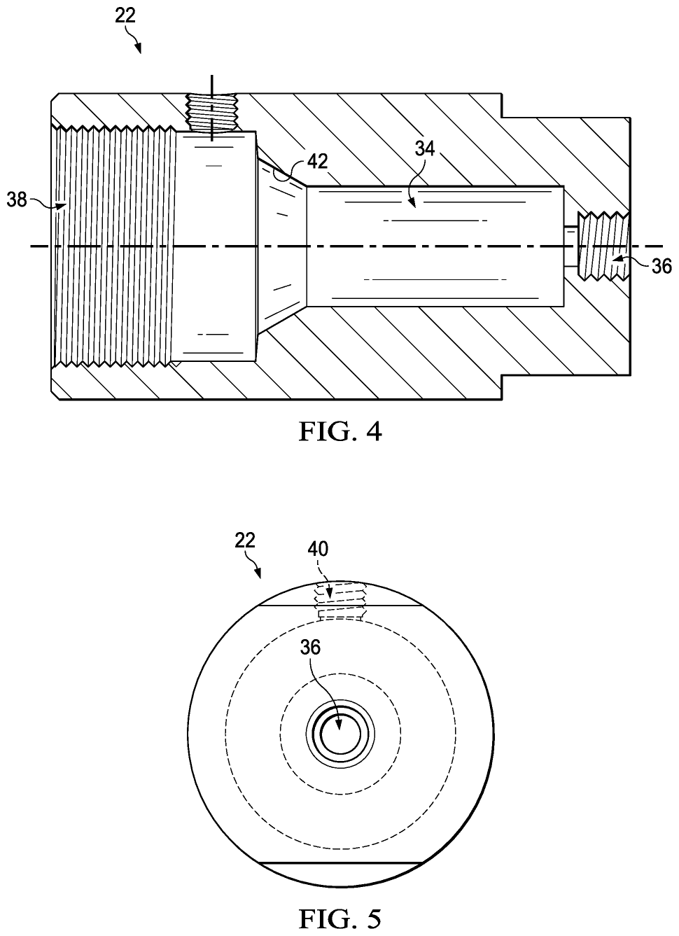

Referring now to FIGS. 4 and 5, the housing 22 can define a test chamber 34 and an inlet port 36 in communication with the test chamber 34. The fluid inlet fitting 28 (FIGS. 1 and 2) can be coupled with the inlet port 36. In one embodiment, the fluid inlet fitting 28 can be threaded into the inlet port 36, but in other embodiments, the fluid inlet fitting 28 can be coupled with the inlet port 36 in any of a variety of suitable alternative arrangements. The housing 22 can define a threaded opening 38 that is in fluid communication with the test chamber 34. The housing 22 can also define a leak detection port 40 that is in fluid communication with the threaded opening 38. A shoulder 42 can be provided between the test chamber 34 and the threaded opening 38.

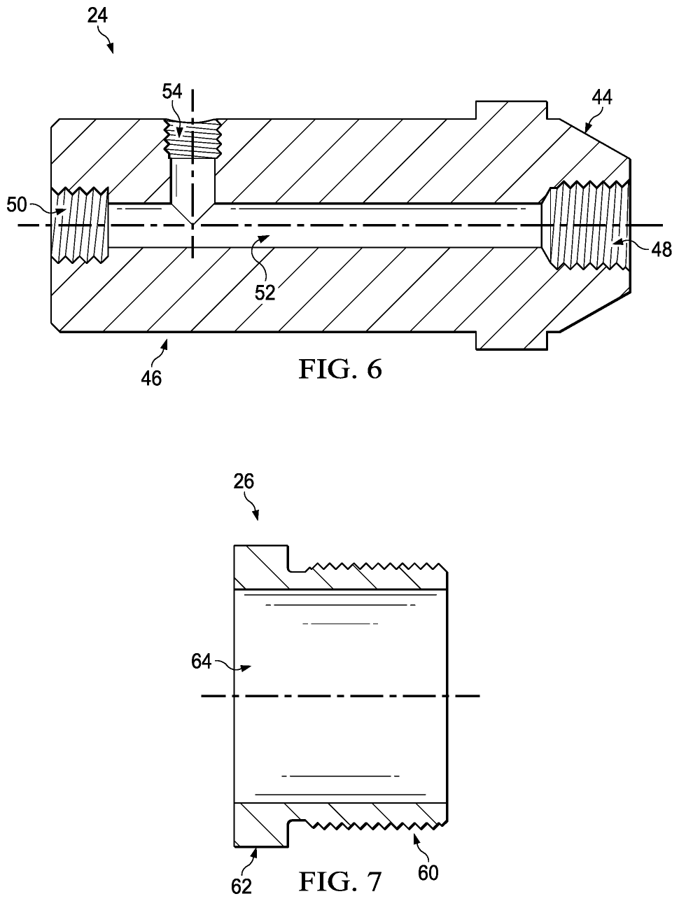

Referring now to FIGS. 2, 3, and 6, the plug body 24 can include a tip portion 44 and a body portion 46 extending from the tip portion 44. As illustrated in FIG. 6, the plug body 24 can define a tip port 48 and a sensor port 50 that are in fluid communication with each other via a passageway 52. The body portion 46 can define an outlet port 54 that is in communication with the passageway 52. In one embodiment, the fluid outlet fitting 31 can be threaded into the outlet port 54, but in other embodiments, the fluid outlet fitting 31 can be coupled with the outlet port 54 in any of a variety of suitable alternative arrangements.

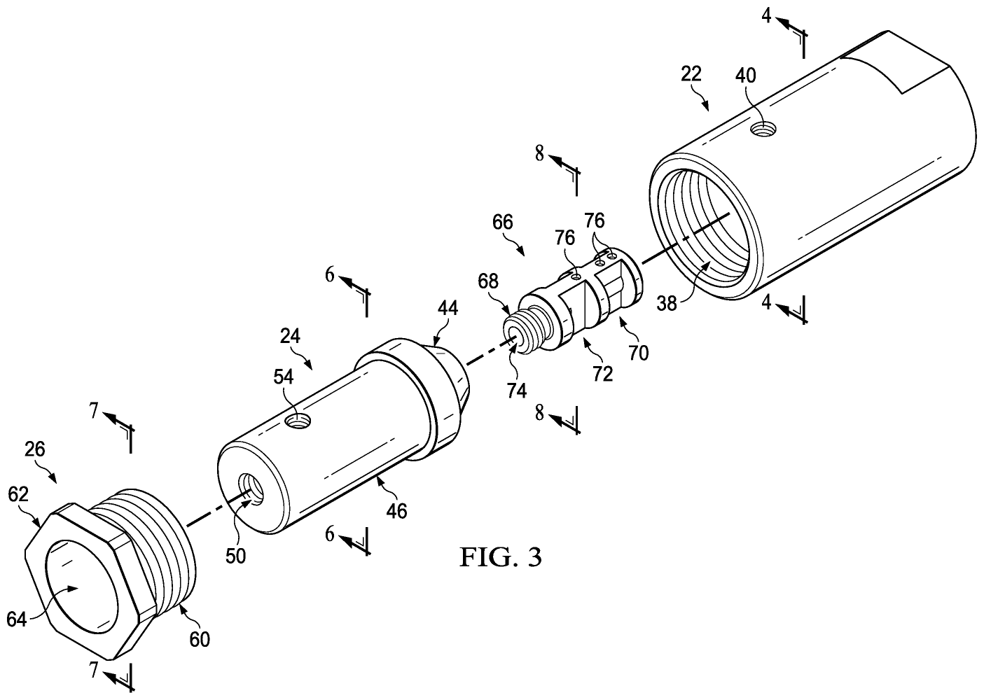

As illustrated in FIGS. 2 and 3, the plug body 24 can be disposed in the threaded opening 38 (FIG. 3) of the housing 22 with the body portion 46 extending from the housing 22. The tip portion 44 can contact the shoulder 42 of the housing 22 to create a sealing interface therebetween. A leak detection fitting 56 can be threaded into the leak detection port 40 (FIG. 3) adjacent the interface between the shoulder 42 and the tip portion 44. The leak detection fitting 56 can be in fluid communication with a controller (not shown). If any fluid from the fluid source 30 (FIG. 1) leaks through the interface between the shoulder 42 and the tip portion 44, the leaked fluid can be communicated through the leak detection fitting 56 and to the controller to facilitate detection of the leak.

Referring now to FIGS. 2, 3 and 7, the compression fitting 26 can include a threaded end 60 and a hex collar 62 and can define a bore 64 (FIG. 3) that extends through each of the threaded end 60 and the hex collar 62. As illustrated in FIG. 2, the compression fitting 26 can surround the plug body 24 such that the body portion 46 of the plug body 24 extends through the bore 64. The threaded end 60 of the compression fitting 26 can be threaded into the threaded opening 38 of the housing 22 such that the threaded end 60 of the compression fitting 26 is interposed between the housing 22 and the plug body 24. The threaded end 60 can engage the tip portion 44 of the plug body 24. When the compression fitting 26 is tightened (e.g., by rotating the hex collar 62 with a wrench), the compression fitting 26 can urge the tip portion 44 into the shoulder 42 of the housing 22 to create an effective seal therebetween. It is to be appreciated that the housing 22 and the plug body 24 can be coupled together using any of a variety of suitable alternative coupling arrangements.

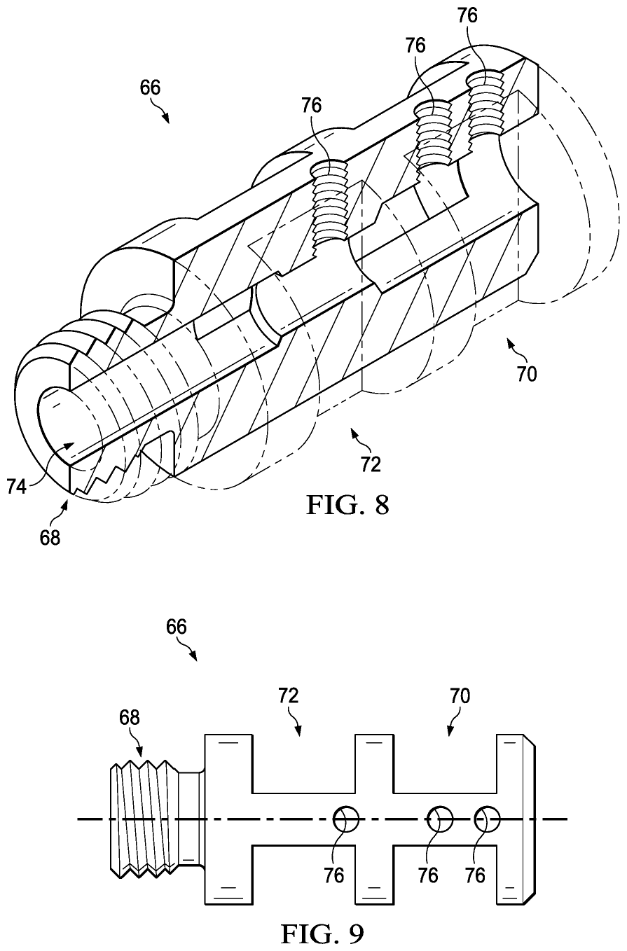

Referring now to FIGS. 2, 3, and 8-10, the dilatometer 20 can include a sample carrier 66 that is disposed in the test chamber 34 of the housing 22 (FIG. 2). As illustrated in FIGS. 8-10, the sample carrier 66 can include a tip portion 68, a sample retention portion 70, and a sensor retention portion 72 that are coupled together and arranged such that the sensor retention portion 72 is disposed between the tip portion 68 and the sample retention portion 70. In one embodiment, the tip portion 68, the sample retention portion 70, and the sensor retention portion 72 can be integrated with each other such that the sample carrier 66 is formed as a unitary one-piece construction. It is to be appreciated however, that the tip portion 68, the sample retention portion 70, and the sensor retention portion 72 can be coupled together via any of a variety of suitable alternative arrangements.

The tip portion 68, the sample retention portion 70, the sensor retention portion 72 can cooperate to define a passageway 74. A plurality of threaded openings 76 can extend to the passageway 74. As illustrated in FIG. 2, the tip portion 68 of the sample carrier 66 can be threadably coupled with the tip port 48 (FIG. 6) of the plug body 24 such that the passageways 52, 74 are in fluid communication with each other. It is to be appreciated that the plug body 24 and the sample carrier 66 can be coupled together using any of a variety of suitable alternative coupling arrangements such as, for example, being provided as a unitary one-piece construction. The sample retention portion 70 can be configured to retain the material sample 32 in the passageway 74. In one embodiment, the material sample 32 can be retained in the passageway 74 with set screws (not shown) that are threaded into the threaded openings 76 located at the sample retention portion 70.

Still referring to FIG. 2, a proximity sensor 78 can be provided that includes a sensor probe 80 and a lead 82 coupled with the sensor probe 80. The sensor probe 80 can be disposed in the sensor retention portion 72 (e.g., in the passageway 74) of the sample carrier 66 and positioned adjacent to the material sample 32. The sensor probe 80 can be rigidly coupled to the sensor retention portion 72 in a manner that prevents the sensor probe 80 from moving relative to the sensor retention portion 72. In one embodiment, the sensor probe 80 can be rigidly coupled to the sensor retention portion 72 with a set screw (not shown) that is threaded into the threaded opening 76 located at the sensor retention portion 72. It is to be appreciated, however, that the sensor probe 80 can be rigidly coupled to the sensor retention portion 72 with any of a variety of suitable alternative securement arrangements, such as, for example, with adhesive.

The lead 82 of the proximity sensor 78 can be routed through the passageways 52, 74, through a sensor fitting 84 that is threaded into (or otherwise coupled with) the sensor port 50 (FIG. 3), and to a controller (not shown). The sensor fitting 84 can be configured to create an effective seal around the lead 82 to prevent pressurized fluid from leaking therethrough. The proximity sensor 78 can be configured to facilitate detection of dimensional changes in the material sample 32 indirectly (e.g., without contacting the material sample 32) during testing. In particular, sensor data (e.g., in the form of an analog or digital signal) generated by the sensor probe 80 can be transmitted to the controller (via the lead 82) to facilitate detection of the dimensional changes in the material sample 32 during testing. In one embodiment, the proximity sensor 78 can comprise a capacitive proximity sensor. It is to be appreciated that any of a variety of suitable alternative dimensional sensors can be provided that facilitate detection of a dimensional change in the material sample 32 during testing.

It is to be appreciated that the sample carrier 66 can encourage repeatability and consistency during testing of multiple material samples with the dilatometer 20. For example, each time a different material sample (e.g., 32) is installed into the sample carrier 66 for testing, the configuration of the sample carrier 66 can allow for each material sample to be installed in a similar position such that the distance between the material sample and the sensor probe 80 are substantially the same for each test, which can encourage accuracy and can enhance the overall quality of the data being collected. It is also to be appreciated that any of the connections between the components of the dilatometer 20 that contact fluid can be provided with a sealing interface that prevents the fluid from inadvertently leaking from the dilatometer 20. In one embodiment, the dilatometer 20, and particularly the sealing interfaces, can be configured to withstand high internal pressures (e.g., up to about 3,500 PSI) when exposed to high testing temperatures (e.g., above nominal and between about 600 degrees F. and about 1,200 degrees F.).

To facilitate testing, the plug body 24 and the sample carrier 66 can initially be provided apart from the housing 22 to allow a user access to the sample carrier 66. The material sample 32 can be installed in the sample retention portion 70, and set screws at the sample retention portion 70 can be threaded into contact with the material sample 32. The plug body 24 can then be installed on the housing 22 by threading the threaded end 60 of the compression fitting 26 into the threaded opening 38 of the housing 22. The dilatometer 20 can be installed in a thermal furnace 86 (FIG. 11) by providing the housing 22 in a passageway 88 defined by the thermal furnace 86. The fluid source 30 can then be activated to pressurize the test chamber 34 and the thermal furnace 86 can be activated to heat the housing 22 (and thus the material sample 32). The response of the dimensional changes of the material sample 32 to the pressurized fluid and the heat can be detected via the proximity sensor 78. In one embodiment, as illustrated in FIG. 11, the thermal furnace 86 can comprise a tube furnace. It is to be appreciated that any of a variety of suitable alternative heat sources can be provided such as, for example, an on-board heating system provided on the dilatometer 20. It is also to be appreciated that a cooling source (e.g., a cryogenic chamber) can be provided in lieu of the thermal furnace 86 to facilitate cooling of the housing 22 and the material sample 32.

It is to be appreciated that the dilatometer 20 can be used to test any of a variety of different types of material samples (e.g., 32) and material types with any of a variety of different types of fluid. Examples of some of the different material types can include metals (e.g., carbon steel and alloy steel), non-metals (e.g., elastomerics and thermoplastics), and ceramics. Examples of some of the different types of material samples can include welding materials, tensile samples, and creep samples). Examples of some of the different types of fluid can include gasses (e.g., hydrogen) or liquids (e.g., water).

One example of a method of conducting a test with the dilatometer 20 on samples of carbon steel or other low alloy steel (collectively “alloy steel”) from crude oil refinery equipment for high-temperature hydrogen attack (HTHA) will now be described. In such an example, the fluid source 30 illustrated in FIG. 1 can produce hydrogen gas. First, a sample of alloy steel is removed from a preexisting piece of equipment, such as a vessel or heat exchanger, for example, at a crude oil refinery. In one embodiment, the sample of alloy steel can be removed using a metal extraction means, such as a scoop sampler, which can allow the equipment to remain in service during and after the sample is removed. A material sample (e.g., 32) of the alloy steel can be bored out of the larger sample. The material sample of the alloy steel can be installed in the sample retention portion 70 of the sample carrier 66 and secured thereto with set screws. The plug body 24 can then be inserted into the threaded opening 38 of the housing 22, and the compression fitting 26 can be threaded into the threaded opening 38 (e.g., with a wrench) until enough force is provided between the shoulder 42 and the tip portion 44 of the plug body 24 to create an effective seal therebetween. The dilatometer 20 can be provided in the thermal furnace 86 (FIG. 11) and heated (typically to a temperature above nominal and between about 600 degrees F. and about 1,200 degrees F.). The fluid source 30 can then be activated (e.g., by opening a shutoff valve (not shown)) to introduce the hydrogen gas into the test chamber 34.

When the material sample of alloy steel is exposed to the hydrogen gas and heated, hydrogen atoms from the hydrogen gas can chemically react with carbon atoms in the alloy steel to form methane gas pockets. These methane gas pockets can cause the material sample of alloy steel to grow (e.g., dimensional change and change rate) which can be detected by the proximity sensor 78. The level of hydrogen and/or heat can be varied during testing, and the response of the material sample can be monitored (e.g., by the controller via the proximity sensor 78) to determine the hydrogen levels, pressure, and/or temperature that cause the material sample of alloy steel to begin failing. This process can be repeated on other material samples collected from the equipment until a sufficient data set has been collected. This data set can then be used to develop assessment data which can be used to determine (as part of an engineering assessment model) the useful life of the equipment from which the sample was taken and/or to determine relative risk of failure (as part of a risk ranking assessment model) of the equipment from which the sample was taken. It is to be appreciated that although the dilatometer 20 is described for use in detecting HTHA in alloy steel, the dilatometer 20 can be used to test the dimensional change of any of a variety of suitable alternative materials as a function of exposure to any type of fluid (e.g., gas or liquid) and/or heat for any of a variety of alternative applications. It is also to be appreciated that prior to testing a material sample from in-service equipment, unadulterated samples (e.g., new or virgin) of the same or similar grades of material as an in-service piece of equipment (e.g., candidate material) can be tested to establish a baseline dataset from which to conduct testing of the in-service equipment.

It is to be appreciated that although the dilatometer 20 is described as being configured for testing of a dimensional change in the material sample 32, the dilatometer 20 can be configured to test any of a variety of additional material characteristics of the material sample 32. In one embodiment, these other material characteristics can be tested by adding an appropriate sensor to the test chamber 34. It is also to be appreciated that, although the dilatometer 20 is described for use in testing the response of the material sample to exposure to pressurized fluid and thermal conditions (e.g., heating or cooling), the dilatometer 20 can be configured to facilitate testing the response of the material sample 32 to exposure to any of a variety of suitable alternative environmental conditions.

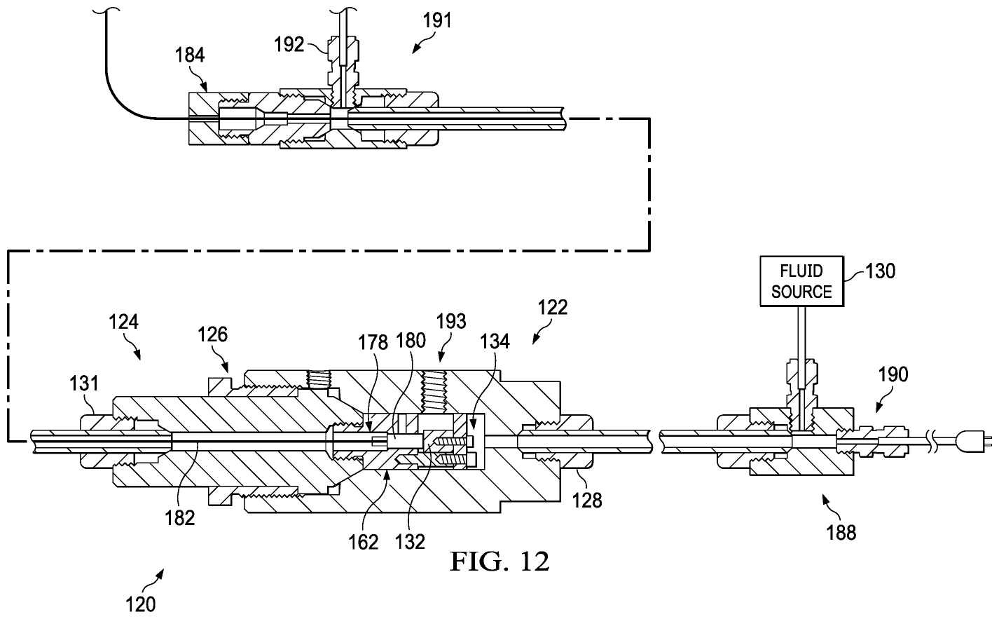

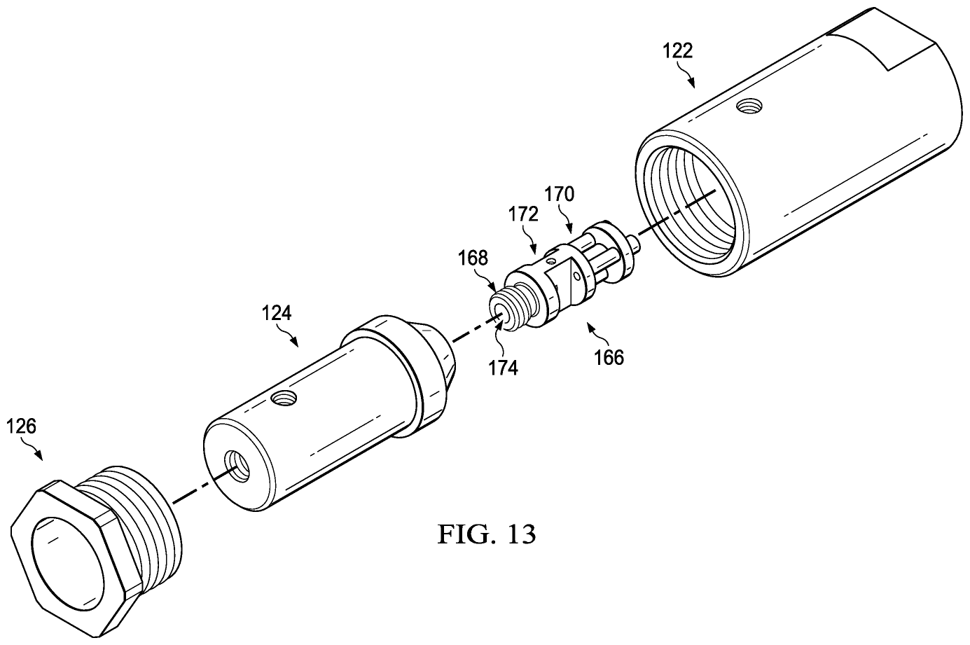

FIGS. 12-15 illustrate an alternative embodiment of a dilatometer 120 that is similar to, or the same in many respects as, the dilatometer 20 illustrated in FIGS. 1-10. For example, as illustrated in FIGS. 12 and 13, the dilatometer 120 can include a housing 122 and a plug body 124 disposed at least partially in the housing 122. Referring now to FIG. 12, a compression fitting 126 can surround the plug body 124 and can be threaded into the housing 122. A fluid inlet fitting 128 can be coupled with the housing 122. The housing 122 can define a test chamber 134. A fluid outlet fitting 131 can be coupled with the plug body 124 and in communication with the test chamber 134. As illustrated in FIGS. 12 and 13, a sample carrier 166 can be coupled with the plug body 124.

Referring again to FIG. 12, a proximity sensor 178 can include a sensor probe 180 that is coupled with the sample carrier 166, and a lead 182 that is routed through the plug body 124 and the fluid outlet fitting 131. However, an input adapter 188 can be in fluid communication with the fluid inlet fitting 128 and a fluid source 130 and can facilitate routing of pressurized fluid from the fluid source 130 to the fluid inlet fitting 128 and to the test chamber 134. A thermocouple 190 can be coupled with the input adapter 188 and configured to detect a temperature of the pressurized fluid. It is to be appreciated that any of a variety of suitable alternative temperature sensors are contemplated that can be associated with the test chamber 134 and configured to facilitate detection of a temperature of the test chamber 134 and/or the pressurized fluid. An output adapter 191 can be in fluid communication with the fluid outlet fitting 131, and a vent fitting 192 and can facilitate routing of pressurized fluid from the test chamber 134 and to the vent fitting 192. A sensor fitting 184 can be coupled with the output adapter 191 and the lead 182 can extend through the sensor fitting 184. A pressure sensor 193 can be coupled with the housing 122 and can extend into the test chamber 134 such that the pressure sensor 193 is in fluid communication with the test chamber 134. The pressure sensor 193 can be used to facilitate detection of a pressure of the pressurized fluid within the test chamber 134.

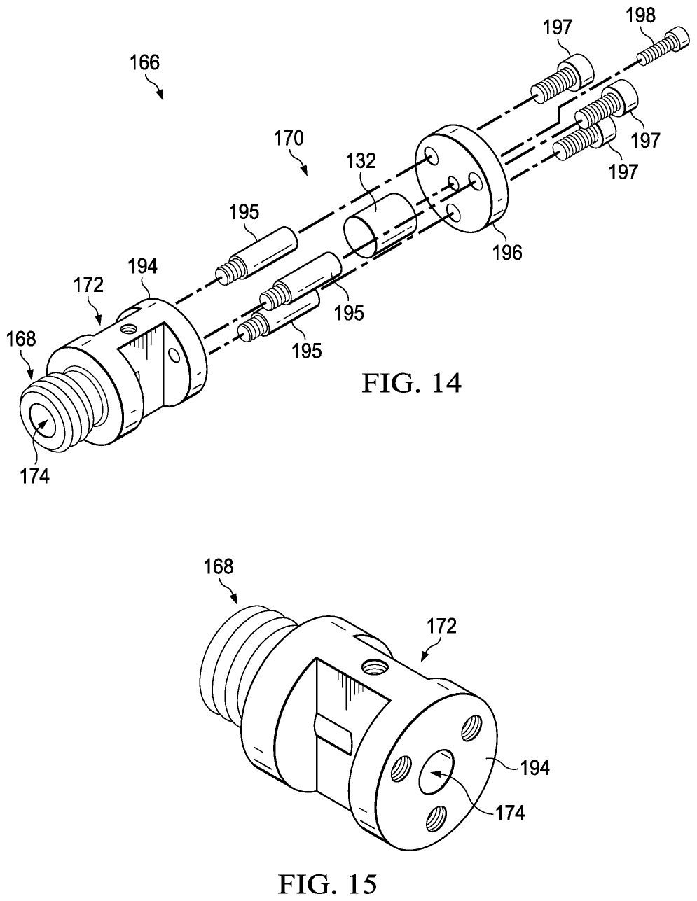

Referring now to FIG. 14, the sample carrier 166 can include a tip portion 168, a sample retention portion 170, and a sensor retention portion 172. The tip portion 168 and the sample retention portion 170 can define a passageway 174 that extends to a support plate 194 (FIGS. 14 and 15). The sample retention portion 170 can include a plurality of threaded posts 195 that are threadably coupled with the support plate 194 and are configured to surround the material sample 132. A cap plate 196 can be coupled with the plurality of threaded posts 195 with a plurality of fasteners 197. The material sample 132 can be coupled to the cap plate with a fastener 198. The support plate 194 and the cap plate 196 can be sized and positioned to firmly retain the material sample 132 between the support plate 194, the threaded posts 195, and the cap plate 196. The sizes and configuration of the threaded posts 195 and the cap plate 196 can be selected to accommodate different sizes and shapes of material samples such that the sample carrier 162 is highly modular and scalable.

The foregoing description of embodiments and examples of the disclosure has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate the principles of the disclosure and various embodiments as are suited to the particular use contemplated. In some embodiments, the drawings can be understood to be drawn to scale. The scope of the disclosure is, of course, not limited to the examples or embodiments set forth herein, but can be employed in any number of applications and equivalent devices by those of ordinary skill in the art. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A dilatometer comprising:
a housing defining a test chamber and an inlet port in communication with the test chamber;
a plug body at least partially disposed in the inlet port and coupled with the housing;
a sample carrier coupled with the plug body and disposed in the test chamber, the sample carrier comprising a sensor retention portion and a sample retention portion, the sample retention portion being configured to retain a material sample thereto;
a proximity sensor disposed in the sensor retention portion and configured to facilitate detection of dimensional changes in the material sample; and
a pressurized fluid source in fluid communication with the test chamber and configured to dispense pressurized fluid thereto.

2. The dilatometer of claim 1 wherein the proximity sensor comprises a capacitance sensor.

3. The dilatometer of claim 1 wherein the sensor retention portion of the sample carrier defines a first passageway and the proximity sensor is at least partially disposed in the first passageway.

4. The dilatometer of claim 3 wherein the sample retention portion further defines the first passageway and the sample retention portion is configured to retain the material sample in the first passageway.

5. The dilatometer of claim 3 wherein:
the plug body defines a sensor port and a second passageway that is in communication with the sensor port and the first passageway;
a sensor fitting is coupled with the sensor port;
the proximity sensor comprises a probe and a lead;
the probe is disposed in the first passageway at the sensor retention portion;
the lead extends through the second passageway and the sensor fitting; and
the sensor fitting is configured to form a seal around the lead to prevent pressurized fluid from leaking therebetween.

6. The dilatometer of claim 1 further comprising a pressure sensor in fluid communication with the test chamber and configured to facilitate detection of a pressure of the pressurized fluid therein.

7. The dilatometer of claim 1 further comprising a temperature sensor associated with the test chamber and configured to facilitate detection of a temperature of the test chamber.

8. The dilatometer of claim 1 wherein:
the housing comprises a shoulder adjacent to the test chamber; and
the plug body includes a tip portion that contacts the shoulder to create a sealing interface therebetween.

9. The dilatometer of claim 8 further comprising a leak detection fitting in fluid communication with the sealing interface and configured to facilitate detection of a leak at the sealing interface.

10. A dilatometer comprising:
a housing defining a test chamber and an inlet port in communication with the test chamber;
a sample carrier disposed in the test chamber and comprising a sample retention portion, the sample retention portion being configured to retain a material sample thereto;
a dimensional sensor coupled with the sample carrier and configured to facilitate detection of dimensional changes in the material sample;
a pressure sensor in fluid communication with the test chamber and configured to facilitate detection of a pressure of a pressurized fluid therein; and
a temperature sensor associated with the test chamber and configured to facilitate detection of a temperature of the test chamber.

11. The dilatometer of claim 10 wherein the dimensional sensor comprises a proximity sensor.

12. The dilatometer of claim 11 wherein the proximity sensor comprises a capacitance sensor.

13. The dilatometer of claim 10 wherein the temperature sensor comprises a thermocouple.

14. The dilatometer of claim 10 further comprising a plug body at least partially disposed in the inlet port and coupled with the housing, wherein:
the plug body defines a sensor port and a passageway that is in communication with the sensor port;
a sensor fitting is coupled with the sensor port;
the dimensional sensor comprises a probe and a lead;
the probe is coupled with the sample carrier;
the lead extends through the passageway and the sensor fitting; and
the sensor fitting is configured to form a seal around the lead to prevent pressurized fluid from leaking therebetween.

15. A sample carrier for a dilatometer, the sample carrier comprising:
a sensor retention portion that defines a passageway for receiving a dimensional sensor, the sensor retention portion being configured to facilitate rigid coupling of the dimensional sensor thereto; and
a sample retention portion coupled to the sensor retention portion and configured to retain a material sample to the sensor retention portion.

16. The sample carrier of claim 15 wherein:
the sample retention portion further defines the passageway; and
the passageway is configured to receive the material sample.

17. The sample carrier of claim 15 wherein the sensor retention portion and the sample retention portion are coupled together in a unitary one-piece construction.

18. The sample carrier of claim 15 wherein the sample retention portion comprises:
a plurality of posts coupled with the sensor retention portion and configured to surround the material sample; and
a cap plate coupled with the plurality of posts and configured to retain the material sample between the plurality of posts.

19. The sample carrier of claim 18 wherein:
the plurality of posts are threadably coupled to the sample retention portion; and
the cap plate is coupled to the plurality of posts with fasteners.

20. The sample carrier of claim 15 in combination with a dimensional sensor, wherein the dimensional sensor comprises a sensor probe that is disposed in the passageway and is rigidly coupled with the sensor retention portion.
